(19) United States
(12) Patent Application Publication
(10) Pub. No.: US 2025/0301940 A1
(43) Pub. Date: Oct. 2, 2025

(54) PIVOTING GROUND ENGAGING ASSEMBLY FOR SEEDERS

(71) Applicant: VADERSTAD INDUSTRIES INC., Langbank (CA)

(72) Inventor: Jordan ESAU, Moosomin (CA)

(73) Assignee: VADERSTAD INDUSTRIES INC., Langbank, SK (CA)

(21) Appl. No.: 18/872,921

(22) PCT Filed: Jun. 19, 2023
(86) PCT No.: PCT/CA2023/050849

§ 371 Date: Dec. 9, 2024

Related U.S. Application Data
(60) Provisional application No. 63/354,155, filed on Jun. 21, 2022.

(51) Int. Cl. A01C 7/20; A01C 5/06

(52) U.S. Cl. CPC A01C 7/201; A01C 5/064; A01C 7/208

(57) ABSTRACT

A pivotal ground engaging assembly for applying either seed, fertilizer or both in the ground is provided, the assembly comprising a pivot joint for pivotally mounting the pivotal ground engaging assembly either directly or indirectly to a frame of an implement. The pivot joint allows the pivotal ground engaging assembly to maintain optimal position when the implement travels through turns so that seed and/or fertilizer furrows remain evenly spaced.

### FIELD OF INVENTION

The present invention relates to a ground engaging assembly for a seeding or planting unit and more particularly to a ground engaging assembly having a pivoting joint for attaching the assembly to an implement frame mounted on wheels, commonly referred to as a toolbar, for travel over the ground in an operating travel direction. The pivoting joint allows the ground engaging assembly to maintain optimal position when the toolbar travels through turns.

### BACKGROUND OF THE INVENTION

A variety of agricultural operations are performed using an implement frame mounted on wheels, or toolbar, which is towed by a pivotally attached vehicle such as a tractor. Seeding and fertilizing are examples. Generally, a seeding unit comprises a plurality of ground engaging assemblies that are attached to the toolbar, which ground engaging assemblies can clear residue, form furrows and deposit seed, fertilizer (single-shoot assemblies) or both (double-shoot assemblies) in the furrows that are formed, etc., as the vehicle moves along the ground towing the toolbar.

In larger operations, the toolbar comprises a plurality of ranks of ground engaging assemblies (e.g., typically three or four) that are staggered in rows, which means that the distance from the front most ground engaging assemblies and the rear most ground engaging assemblies can be significant, e.g., typically ranging from about 96 inches with three ranks of ground engaging assemblies and as high as 144 inches with four ranks of ground engaging assemblies. Thus, when the vehicle makes a turn, the ground engaging assemblies can deviate from the optimal row spacing of seed or fertilizer or both. For example, in some instances, the ground engaging assemblies will form furrows that tend to bunch up so that the products are too close together (or overlap). In some instances, there will be gaps formed where no seed, fertilizer or both are deposited into the ground. This results in inefficient operation and suboptimal distribution of seed and/or fertilizer, consequently resulting in lower yields.

### SUMMARY OF THE INVENTION

The present invention relates to a ground engaging assembly for a seeding or planting unit and more particularly to a pivotal ground engaging assembly having a pivoting joint for attaching the assembly to an implement frame mounted on wheels for travel over the ground in an operating travel direction. The pivoting joint allows the ground engaging assembly to maintain optimal position when the implement travels through turns to prevent overlap.

In one aspect, a pivotal ground engaging assembly is provide that is pivotally mounted to a frame of an implement mounted on wheels for travel over the ground in an operating travel direction for applying either seed, fertilizer or both in the ground, said assembly comprising:
a trailing arm having a proximal end and a distal end;
at least one ground engaging tool mounted to the trailing arm between the proximal end and the distal end of the trailing arm;
a pivot joint attached to the frame of the implement and operable for pivotally attaching the trailing arm to the pivotal joint allowing the pivotal ground engaging assembly to swivel from side to side relative to the frame.

In one embodiment, the pivot joint comprising a stopping device operable to limit the degree of side to side movement of the pivotal ground engaging assembly. In a preferred embodiment, the stopping device allows the pivotal ground engaging assembly to move 20 degrees to the left and 20 degrees to the right. It is understood, however, that the stopping device can be set to provide greater than 20 degree movement left and right or less than 20 degree movement left to right.

In one embodiment, the pivot joint comprises a locking device that is engaged when the pivotal ground engaging assembly is lifted into the transport position to prevent the pivotal ground engaging assembly from moving side to side during transport. In one embodiment, the locking device comprises a locking pin that is inserted into a groove present on the pivot joint whereby the locking pin engages with the groove when the pivotal ground engaging assembly is lifted into the transport position.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 (PRIOR ART) is a schematic top view of a field being seeded or fertilized using a plurality of prior art single shoot ground engaging assemblies that are rigidly attached to a toolbar that is making a 300 inch radius turn in the field.

FIG. 2 is a schematic top view of a field being seeded or fertilized using a plurality of single shoot pivotal ground engaging assemblies that are pivotally attached to a toolbar that is making a 300 inch radius turn in the field.

FIG. 3 is a perspective side view of a double shoot pivotal ground engaging assembly of the present invention.

FIG. 4A is a perspective side view of a pivot joint useful in the present invention in the unlocked position.

FIG. 4 is a perspective side view of the pivot joint of FIG. 4A in the locked position.

FIG. 5 is a top view of the pivotal ground engaging assembly of FIG. 3 in three positions, namely, pivoted 20 degrees to the left, in center position, and pivoted 20 degrees to the right.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

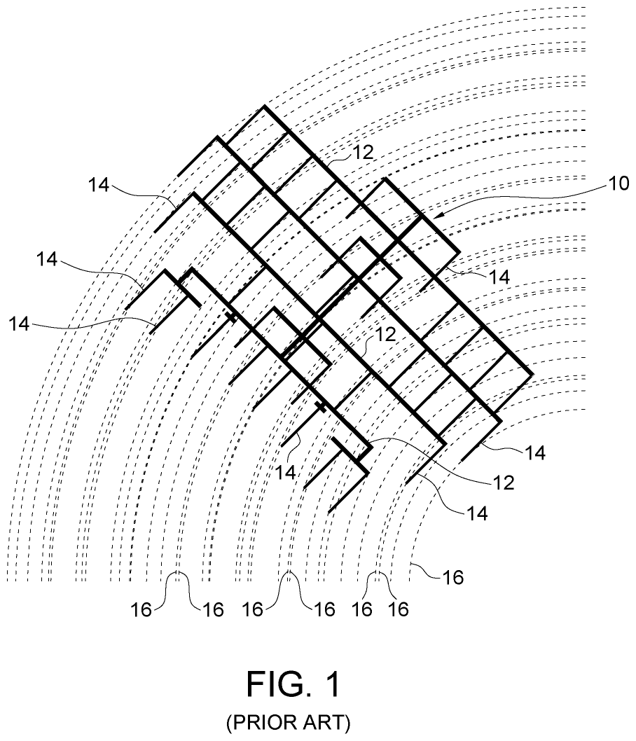

Referring first to FIG. 1 (PRIOR ART), FIG. 1 illustrates the problem associated with toolbars where the ground engaging assemblies are rigidly attached thereto. In particular, FIG. 1 depicts a typical toolbar 10 comprising a plurality of frame members 12 on which a plurality of ground engaging assemblies 14 are rigidly attached. Because the ground engaging assemblies 14 are rigidly attached to their respective frame members 12, they have very little lateral or side to side movement. As depicted in FIG. 1, the ground engaging assemblies 14 are single shoot ground engaging assemblies comprising a single ground engaging tool, in this example a ground opener that form a single furrow for depositing seed or fertilizer. The dotted lines are furrows 16 that are formed by each of the ground openers. However, as can be seen in FIG. 1, when the toolbar makes a 300 inch radius turn, for example, the spacing between the furrows 16 is uneven and in some instances the furrows 16 overlap one another. This results in poor crop growth. Such uneven spacing and potential overlap is exacerbated the tighter the turn.

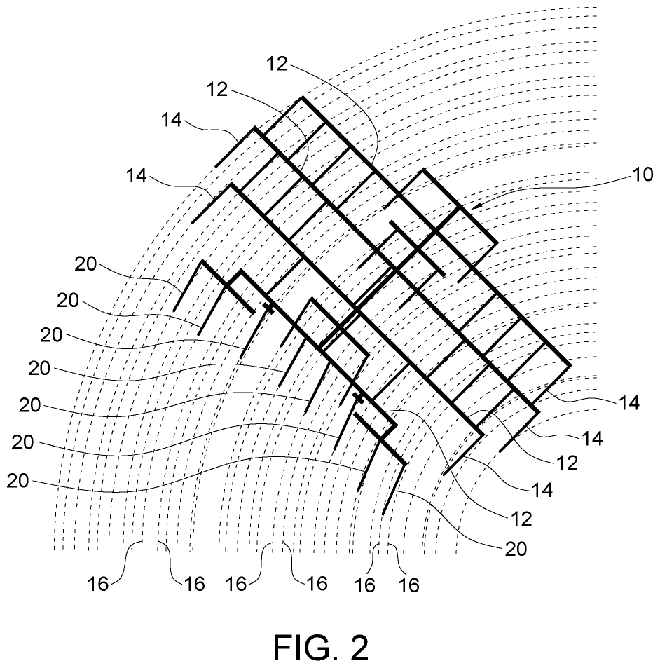

Referring now to FIG. 2, instead of all of the ground opening assemblies being rigidly attached to their respective frame members, a rear row of ground engaging assemblies 20 of the present invention have a pivoting joint for pivotally attaching the rear row assemblies 20 to their respective frame members 12 (referred to hereinafter as “pivoting ground engaging assemblies”). When a rear row of pivoting ground opener assemblies are used in a seeding or fertilizing operation, it can be seen in FIG. 2 that the furrows 16 formed by the toolbar 10 are uniformly spaced and there is little to no overlap. As in FIG. 1, all of the ground engaging assemblies in FIG. 2 are depicted as single shoot ground engaging assemblies. It is understood that all of the ground engaging assemblies could be pivotally attached to their respective frames, however, it was discovered that having only the rear row of assemblies capable of pivoting worked to significantly improve furrow spacing and is more economical. The pivoting ground engaging assemblies 20 are described in more detail in the following embodiments.

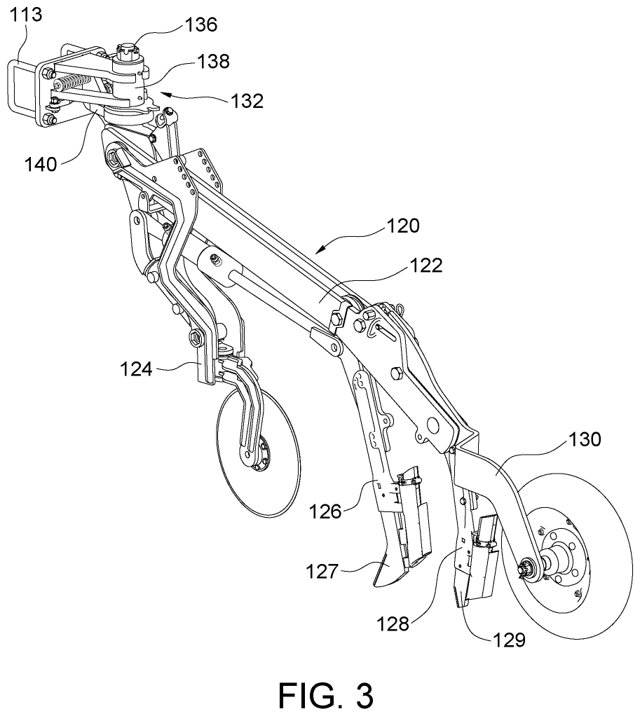

FIG. 3 illustrates one embodiment of a pivoting ground engaging assembly of the present invention. In this embodiment, pivoting ground engaging assembly 120 comprises a trailing arm 122 having a plurality of ground engaging tools, namely, a residue clearing tool 124, a fertilizer opener 126 having a knife 127 for forming a fertilizer furrow and depositing fertilizer therein, a seed opener 128 having a seed knife 129 for forming a seed furrow and depositing seed therein, and a packer or gauge wheel 130, which acts to both gauge the pivoting ground engaging assembly 120 but also to pack the loose soil that is produced when the openers form the furrows. It is understood that fertilizer and seed knives 127, 129, respectively, can also be coulter disks or any other furrow forming implement known in the art. It is also understood that the pivoting ground engaging assembly of the present invention may comprise any number of ground engaging tools, for example, a single seed opener and a packer or gauge wheel, a single fertilizer opener and a packer or gauge wheel, etc.

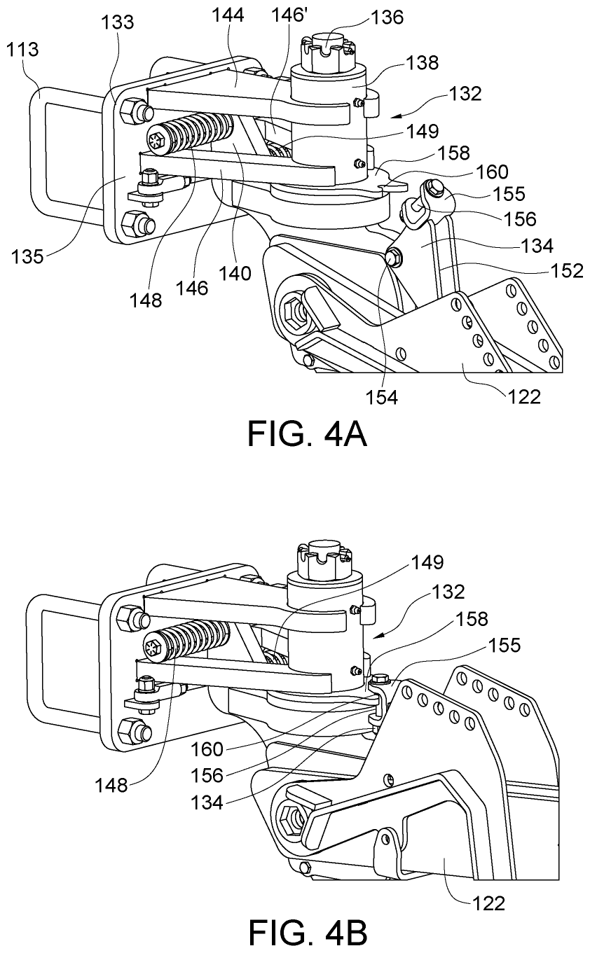

The proximal end of the trailing arm 122 of pivotal ground engaging assembly 120 comprises a first joint member 136 in the form of a cylindrical projection for pivotally attaching to pivot joint 132. The proximal end of trailing arm 122 further comprises a protruding tongue 140, which function will be described in more detail below. As can be seen more clearly in FIG. 4A, pivot joint 132 comprises a substantially rectangular plate 133 having a front face 135 and a back face 137, which can be bolted by any number of bolts 142 to frame bracket 113, which bracket 113 attaches to a transverse main frame beam (not shown) such that the back face 137 is in contact with the frame beam. In this embodiment, pivot joint 132 further comprises locking member 134. Pivot joint 132 further comprises a second joint member 138, which is a hollow cylinder adapted to receive the first joint member 136 that is attached at the proximal end of trailing arm 122, thereby pivotally connecting the trailing arm 122 to the second joint member 138. Thus, first joint member 136 and second joint member 138 have a male-female connective relationship. The pivot joint 132 and its operation will be described in more detail below. It is understood, however, that other pivot joints could be used having different configurations and pivot joint 138 is used as example only.

With reference now to FIGS. 4A and 4B, FIG. 4A shows pivot joint 132 in the unlocked position. Extending from the second joint member 138 towards back plate 133 is an upper arm 144 and two substantially planar lower arms 146, 147. Upper arm 144 and lower arms 146, 146′ are spaced apart substantially parallel to each another. The proximal end of upper arm 144 is attached to the front face 135 of plate 133 at or near the top of plate 133. The proximal ends of lower arms 146, 146′ are attached to the front face 135 of plate 133 at or near the middle of plate 133. Housed in the space formed by the upper arm 144 and lower arms 146, 146′ is a first spring 148, which rests at one end onto protruding tongue 140 of trailing arm 122, which protruding tongue 140 is positioned in a space formed between lower arms 146, 146′. A second spring 149 is positioned below lower arms 146, 146′, which also rests at one end onto protruding tongue 140 of trailing arm 122. Hence, the first and second springs, 148 and 149, respectively, are held with one end in contact with the protruding tongue 140 and the other end in contact with a spring alignment rod (which in this case is a bolt). The spring alignment rods pass through slots in the protruding tongue 140 and are coupled to the plate 133 accordingly.

Thus, when trailing arm 122 (and, as such, pivoting ground engaging assembly 120) moves from side to side, each of first spring 148 and second spring 149 will compress against the protruding tongue accordingly. However, the compressibility of each spring will be limited, hence, limiting the horizontal side to side movement of the pivoting ground engaging assembly 120 accordingly. Further, in this embodiment, the tongue 140 protrudes between lower arms 146 and 146′, which arms act as the stoppers for the rotation of the ground engaging assembly.

In one embodiment, pivot joint 132 may further comprises a stopping device comprising two opposing stoppers which allows the pivoting ground engaging assembly 120 to only pivot a certain degree to the left or right. The two opposing stoppers may be separated from one another at a distance to provide the desirable degree of horizontal movement of pivotal ground engaging assembly 120. Thus, the protruding tongue 140 left and right movement can be further limited by the stoppers.

Pivot joint 132 may further comprise a locking device 134 which is attached to trailing arm 122 via a triangular plate 152 (which triangular plate may itself be comprised of two parallel triangular plates as shown in FIG. 4A) by means of bolt 154. Attached to the proximal end of triangular plate 152 is a pin holder 155 for securing locking pin 156 thereto. Opposite and spaced from locking pin 156 is a locking pin receiving member 158 having a groove 160 for receiving and securing locking pin 156 when pivotal ground engaging assembly is in a raised position, such as when being transported. This is shown more clearly in FIG. 4B.

FIG. 4B shows the pivot joint in the locked position. As can be seen in FIG. 4B, the locking pin 156 of locking device 134, which is attached to trailing arm 122, is inserted in groove 160 of locking pin receiving member 158. Thus, the pivoting ground engaging assembly is locked in the center position and can no longer pivot from side to side. If the assembly could pivot when the wings of the machine were folded into transport position, it would likely contact other parts of the machine (including other assemblies) causing damage. Further, the locking device 134 ensures that the pivoting ground engaging assembly is fixed during transport such that it cannot swing out and hit oncoming vehicles or signs. Thus, to prevent the assembly from pivoting, first spring 148 and second spring 149 operate to push the assembly to its centred position when the pivoting ground engaging assembly is lifted out of the ground. As the assembly rises, the locking pin 156 engages with groove 160, which locks the assembly in place. When the assembly is lowered again, the locking pin 156 disengages from groove 160 and the assembly is free to pivot again.

Hence, when a ground engaging tool (such as a fertilizer opener 126 having a knife 127 as shown in FIG. 3) is engaged with the ground, the forces from the knife 127 overcome the springs which allows the ground engaging assembly to pivot and follow the desired path. As soon as the fertilizer opener 126 disengages from the ground and lifts, either the top or the bottom spring (depending on the direction the assembly is turned) pushes the ground engaging assembly and centers it, or, at the very least, positions the assembly close to center. Then, as the ground engaging assembly continues to lift, the locking pin 156 is guided into the groove 160 by the curved profile on either side of it. This helps to fully align the pin and center it fully if the springs haven't done that completely. The springs are always pushing the assembly to center, but they are only able to actually move the assembly when it's in the air because the ground engagement forces are stronger than the springs.

It is understood, however, that any pivot joint having a locking mechanism could be used to pivotally attach ground opening assemblies and lock the ground opening assemblies when in a transport position and that the pivot joint and locking mechanism shown in FIGS. 4A and 4B are simply illustrative of one way to achieve the goals of the present invention.

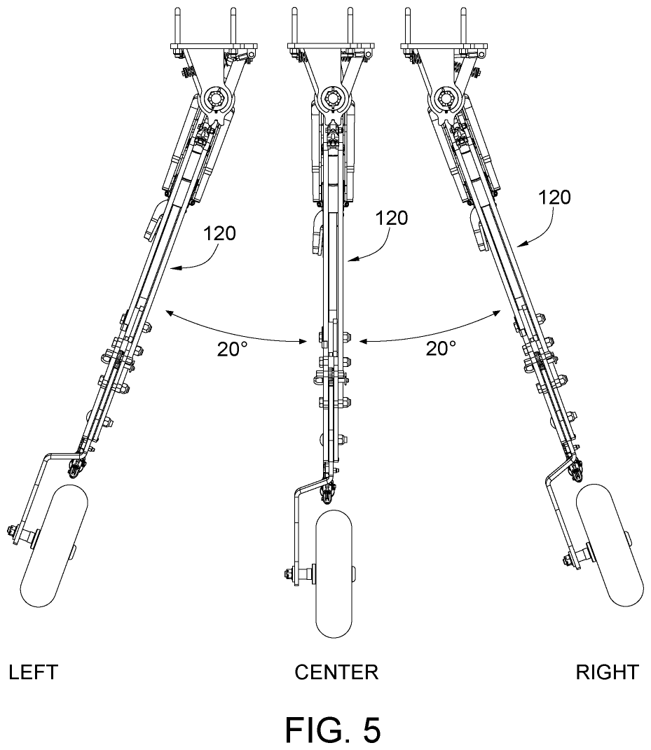

FIG. 5 illustrates a pivoting ground engaging assembly 120, which can pivot 20 degrees to the left and 20 degrees to the right from center. Thus, the pivoting ground engaging assembly having a pivoting joint at the front of the assembly allows it to turn 20 degrees left and right to maintain optimal row position through turns. In addition to improving the row spacing, allowing the assembly to pivot also reduces the twisting force on the bushings, pins, and wear plates, which has been known to cause excessive wear.

### Interpretation

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A pivotal ground engaging assembly pivotally mounted to a frame of an implement mounted on wheels for travel over the ground in an operating travel direction for applying either seed, fertilizer or both in the ground, said assembly comprising:
(a) a trailing arm having a proximal end and a distal end;
(b) at least one ground opener mounted to the trailing arm between the proximal end and the distal end of the trailing arm; and
(c) a pivot joint attached directly or indirectly to the frame of the implement and operable for pivotally attaching the trailing arm to the frame thereby allowing the pivotal ground engaging assembly to swivel from side to side relative to the frame.

2. The pivotal ground engaging assembly of claim 1, wherein the pivot joint comprises a stopping device operable to limit the degree of side to side movement of the pivotal ground opener assembly.

3. The pivotal ground engaging assembly of claim 2, wherein the stopping device allows the pivotal ground engaging assembly to move about 20 degrees to the left and about 20 degrees to the right.

4. The pivotal ground engaging assembly of claim 1, wherein the pivot joint comprises a locking device that is engaged when the pivotal ground engaging assembly is lifted into the transport position to prevent the pivotal ground engaging assembly from moving side to side during transport.

5. The pivotal ground engaging assembly of claim 4, wherein the locking device comprises a locking pin that is inserted into a groove present on the pivot joint, whereby the locking pin engages with the groove when the pivotal ground engaging assembly is lifted into the transport position.

6. The pivotal ground engaging assembly of claim 1, wherein the pivot joint comprises a centering mechanism which acts to align the ground engaging assembly in its centered position when the pivotal ground engaging assembly is lifted from the ground.

7. The pivotal ground engaging assembly of claim 6, wherein the centering mechanism comprises a pair of opposing springs.

8. The pivotal ground engaging assembly of claim 1, wherein the ground engaging tool is a residue clearing tool, a fertilizer opener, a seed opener or a packer or gauge wheel, or any combination thereof.
